(19) United States
(12) Patent Application Publication
(10) Pub. No.: US 2005/0180338 A1
(43) Pub. Date: Aug. 18, 2005

(54) Swapping voice and video calls

(75) Inventors: Hannu Pirila, Littoinen (FI); Balazs Bertenyi, Budapest (HU)

Correspondence Address: SQUIRE, SANDERS & DEMPSEY L.L.P., 14TH FLOOR, 8000 TOWERS CRESCENT, TYSONS CORNER, VA, 22182, US

(73) Assignee: Nokia Corporation

(21) Appl. No.: 11/053,958

(22) Filed: Feb. 10, 2005

Related U.S. Application Data
(60) Provisional application No. 60/545,082, filed on Feb. 17, 2004.

(51) Int. Cl. H04J 3/14; H04J 1/16; H04L 1/00; H04L 12/26; H04J 3/22

(52) U.S. Cl. 370/252; 370/310; 370/465

(57) ABSTRACT

A mobile station and method thereof are provided to communicate with one or more communication networks or stand-alone devices and establishing and monitoring a quality performance level of a video call. A controller in the mobile station establishes the video call between the mobile station and a receiver, monitors the quality performance level of the video call, determines whether the quality performance level of the video call is less than a threshold level, and, when the quality performance level is below the threshold level, establishes the voice call and dynamically swaps the video call with the voice call and vice-versa based on determining the quality performance level and signal strength.

### REFERENCE TO RELATED APPLICATIONS

This application claims priority of U.S. Provisional Patent Application Ser. No. 60/545,082, filed Feb. 17, 2004. The subject matter of this earlier filed application is hereby incorporated by reference.

### BACKGROUND OF THE INVENTION

1. Field of the Invention

The present invention relates to a mobile station and method thereof to dynamically swap a video call with a voice call when a video coverage has degraded to an unacceptable level.

2. Description of the Related Art

Mobile Video Telephony provides real time synchronized video and audio communication between customers of this service. The customer is able to access video telephony services via a mobile handset. For instance, the video call enriches communication between customers because an image component of the video call complements and adds value to voice communication. For instance, during vacation, the video call allows a customer to share scenes of the vacation spot visiting with another person at a remote location. Also, in business meeting, the video call increases efficiency by allowing customers at remote locations to conduct business.

A gap has recently been identified within 3GPP specifications and mobile systems regarding the rendering of video telephony services. When the customer is moving out of coverage of a service area while having a circuit switch video call, the video quality gradually degrades and the call is eventually terminated. That is, both, video and voice/audio components of the call are terminated.

In general, circuit switched video telephony (e.g. UDI (Unrestricted Digital Information) 64 kbit/s bearer service) suffers from a lower coverage area range compared to voice (e.g. 12.2 kbps AMR (Adaptive Multi-Rate)). As such, uncovered areas for video telephony are likely to exist throughout operator networks (e.g. within buildings). Most customers consider video telephony as one of the major service differentiator brought by Universal Mobile Telecommunications System (UMTS) in the early days and this UMTS adoption take off might be jeopardized if the video telephony services are unreliable and user experience unacceptable.

Accordingly, a mobile station and method thereof are needed to handle requirements for dynamic video-voice swapping, without impacting standardized interfaces. Thus, a solution is needed that works for Integrated Services Digital Network (ISDN) User Part (ISUP) based networks, and, preferably, one that does not impact the standardized interfaces.

### SUMMARY OF THE INVENTION

According to an embodiment of the present invention, there is provided a mobile station or calling party communicating with receiving parties or one or more communication networks or stand-alone devices and monitoring a quality performance level of a video call. The mobile station includes a controller establishing the video call between the mobile station and a receiver, monitoring the quality performance level of the video call, determining whether the quality performance level of the video call is less than a threshold level, and, when the quality performance level is below the threshold level, establishing the voice call.

According to an embodiment of the present invention, there is provided a method for swapping a video call with a voice call between calling and receiving mobile stations. The method includes establishing the video call between the calling and receiving mobile stations, monitoring a quality performance level of the video call, and determining whether the quality performance level of the video call is less than a threshold level. The method further includes establishing the voice call when the quality performance level of the video call is below the threshold level, and dynamically swapping the video call with the voice call when the quality performance level of the video call is below the threshold level.

According to an embodiment of the present invention, there is provided a method for swapping a video call with a voice call between calling and receiving parties or mobile stations. The method includes establishing the video call between the calling and receiving parties or mobile stations, monitoring a quality performance level of the video call, and determining whether the quality performance level of the video call is less than a threshold level. The method further includes establishing the voice call when the quality performance level of the video call is below the threshold level, dynamically swapping the video call with the voice call when the quality performance level of the video call is below the threshold level, continuously monitoring the quality performance level of the video call and signal strength of available radio cells, and reestablishing the video call and dynamically swapping the voice call back to the video call when the quality performance level of the video call is above the threshold level.

According to an embodiment of the present invention, there is provided a mobile station communicating with one or more communication networks or stand-alone devices. Controller means is provided for establishing a video call between the mobile station and a receiver, for monitoring a quality performance level of the video call, for determining whether the quality performance level of the video call is less than a threshold level, and, when the quality performance level is below the threshold level, for establishing the voice call.

### BRIEF DESCRIPTION OF THE DRAWINGS

Further embodiments, details, advantages and modifications of the present invention will become apparent from the following detailed description of the preferred embodiments which is to be taken in conjunction with the accompanying drawings, in which:

FIG. 1 illustrates a conventional video telephony architecture;

FIG. 2 illustrates a configuration set up to swap between a video call and a voice call, in accordance with an embodiment of the present invention;

FIG. 3 illustrates an exemplary mobile station as a calling party to communicate with one or more communication networks or stand-alone devices and to monitor a quality performance level of the video call, in accordance with an embodiment of the present invention; and

FIG. 4 illustrates a flow chart illustrating operations associated with swapping between the video call and the voice call, in accordance with an embodiment of the present invention.

### DETAILED DESCRIPTION OF THE PREFERRED EMBODIMENTS

Reference will now be made in detail to the preferred embodiments of the present invention, examples of which are illustrated in the accompanying drawings. A mobile station and method thereof are provided to simultaneously establish a voice call, which includes a speech, voice, or audio part, and a video call, which includes the speech, voice, or audio part and a video part. In an embodiment of the present invention, the mobile station and method thereof allow a dynamic or automatic swap the video call with the voice call using triggering rules, such as, when a quality performance threshold level of the video call degrades to an unacceptable quality threshold level. The dynamic or automatic swap would swap the service of the video call with the voice call without service disruption, in real time or in an automated manner without human intervention. Thus, when the mobile station and method thereof determine that the quality threshold level of the video call has degraded to an unacceptable level, a user would simply experience a removal of the video call without disruption of the voice call.

The value of the quality threshold level may vary depending on a particular application. That is, in accordance with an embodiment of the present invention, a recognition that the video call may be critical of being lost or terminated may be based on threshold values of parameters such as carrier to interference, signal to noise ratio, bit error rate or block error rate, or receive and transmit quality of the network. Similarly, when the voice call is in progress between two users, the recognition that the video call can be established or re-established may be based on the threshold values of the parameters. In general, one or more of the parameters and measurements relevant to the quality of the connection between the user terminal and the network/network elements, may be used in the various embodiments to be later described.

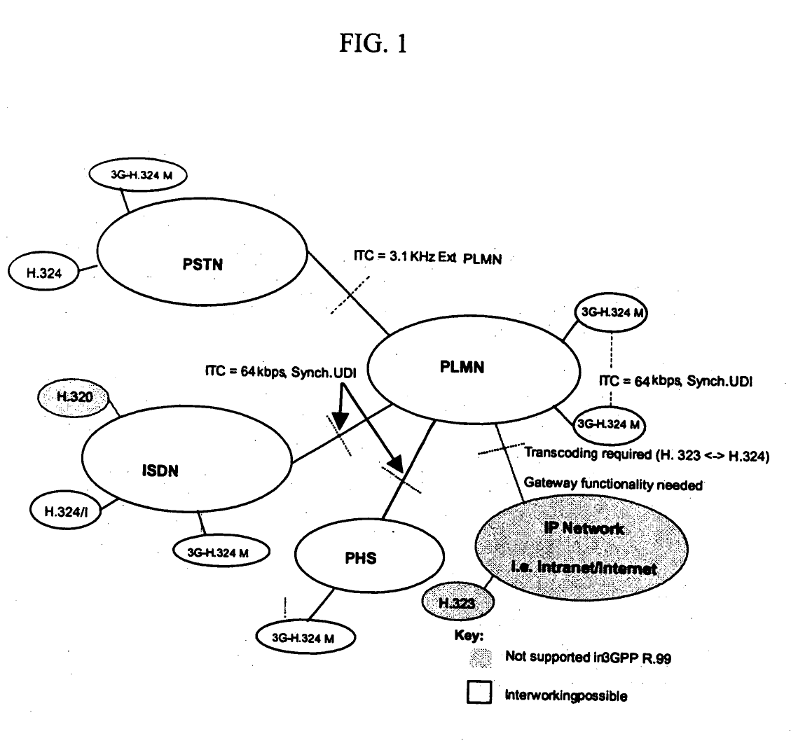

A potential scope of video telephony architecture using 3GPP (Third Generation Partnership Project) standards is illustrated in FIG. 1. The video telephony architecture combines a Public Land Mobile Telecommunications Network (PLMN), for example as specified in GSM (Global System for Mobile Communications) standards, TDMA (Time Division Multiple Access) standards, CDMA (Code Division Multiple Access) standards, 3G Third Generation cellular system standards (3GPP), as well as, in Signalling System No. 7, IS-41 and IS-95 protocol standards, and at least another network not using said standards; for example a wired packet switching or public switched telephone network PSTN/ISDN, INTERNET. Integrated Services Digital Network (ISDN) supports isochronous (regular timed) data transmission and the bandwidth is guaranteed once the connection is established. With ISDN, all information such as audio, data and video data is transmitted in digital form at high speed over the PSTN.

The connectivity of FIG. 1 may require a synchronous, transparent, circuit switched bearer at either 32/64 kbps UDI for digital connections. The connectivity between the PLMN and PSTN may include a lower bandwidth (synchronous, transparent, 3.1 KHz audio CS (Circuit Switched) bearer at 28.8 kbps) than the pure PLMN case, resulting in a degraded call quality (audio and video). For the connectivity between the PLMN and ISDN, in the CS domain, business video conferencing systems are based on H.324/I or the legacy H.320 standard. H.320 interworking may require a Gateway. In this instance, connectivity may be supported via 64 kbps UDI.H.324/I and may require some transcoding to be performed, for instance, via a transcoding gateway. Terminals incorporating a client based on the 3G-324M standard can also be deployed within ISDN networks to simplify the interconnection scenario and reduce a need to transcode.

FIG. 1 also illustrates mobile access to IP (Internet Protocol) network based video systems. As the 3GPP H.324M is used in 3G PLMNs and H.323 is used within the IP network, a Gateway is needed to establish such video call. Conventional levels of connectivity may used to connect to the IP network. The level of connectivity may have to be considered with the gateway functionality. The connectivity of the PLMN with a personal handy phone system (PHS) may be supported via 64 kbps UDI.

There are several situations where swapping between video and voice calls may be needed. For instance, the user using a user terminal/mobile station moving from a good 3G coverage (i.e., able to support 64 kbit/s uplink) into “fringe 3G coverage” (i.e., able to support voice but not video on the uplink) or moving from good 3G coverage into 2G coverage (e.g., at a corner, or entry into a building).

According to an embodiment of the present invention, the mobile station and method thereof may be provided in a core network, such as Service Change and UDI Fallback (SCUDIF), to swap between the video and voice calls. Providing the mechanism in the core network may impact standardized interfaces, but would present a more sophisticated solution especially from end-user charging point of view. In introducing the mechanism in the core network to swap between the voice and video calls, the core network would be aware that these two calls belong logically together, and hence could be charged appropriately.

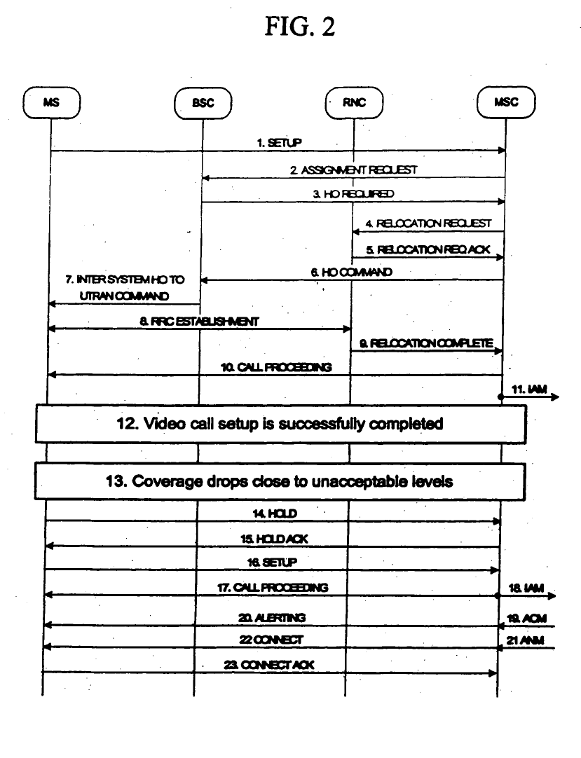

FIG. 2 illustrates the user terminal or mobile station (MS) operatively connected to a base station controller (BSC), which is controlled by a Radio Network Controller (RNC). A Mobile Switching Center (MSC) forwards the connections to the rest of the network (shown in FIG. 1). The RNC which controls, i.e., manages, the connection to the MS, communicates with the MS using certain protocols, such as RLC (Radio Link Control), MAC (Medium Access Control) and RRC (Radio Resource Control) protocols. Although one RNC is illustrated, a person of ordinary skill in the art will appreciate that multiple RNCs and multiple MSCs may be provided for situations such as, when the mobile station initiates connections while located within a cell controlled by the RNC, and later moves away from that cell to another, which is controlled by another RNC.

The MS and method thereof of the present invention may be applied as described in the following examples.

The voice call is active between two users. The MS continuously monitors a coverage status to indicate to the user initiating the voice call when sufficient coverage is available for initiating the video call. Also, the MS continuously monitors the signal strength of available radio cells. When coverage is available, the user may initiate the video call. In one instance, the MS may only keep or maintain the voice call if a triggering rule is met, such as the video coverage is at a critically low level, or if the user wishes not to be on the video call. For instance, the MS would determine that the triggering rule has been met indicative that the video coverage is at the critically low level or close to the unacceptable quality threshold level and transmit a message to the MSC. The MSC would then receive the message and process the message to mean, for instance, that the MS is moving out of coverage for an active video service or that, due to noise or other interferences, coverage for the active video service is not possible. The MSC would then switch or swap the service from the video call with the voice call and vice-versa based on determining the quality performance level and signal strength.

When the video call is active between two users, the MS may activate and or re-activate the voice call if the video coverage drops close to the unacceptable quality threshold level. The triggering rule could enable the voice call either dynamically/automatically by the MS or through user intervention.

FIG. 2 also illustrates a configuration to set-up to swap between the video call and the voice call, in accordance with an embodiment of the present invention. Once the quality of the video call is close to the unacceptable quality threshold level indicative of poor coverage to support the video call, the MS initiates a set-up of the back-up voice call. Operations 1-23 illustrated in FIG. 2 illustrate the initiation of the video call, the determination of whether the video call is close to the unacceptable quality threshold level, and the swapping of the video call with the voice call, in accordance with an embodiment of the present invention. Each operation is described as follows.

Operation 1. The MS requests the video call by passing a SETUP message to the mobile switching center (MSC). The SETUP message includes one Bearer Capability Information Element (BCIE) with Other Rate Adaption set to “H.233 & H.245” and the called number is the same as for the voice call. According to an embodiment of the present invention, the MS may be located in a Global System for Mobile telecommunication (GSM) cell when the video call is initiated.

Operation 2. The MSC sends to the base station controller (BSC) an ASSIGNMENT REQUEST message including a Service Handover IE set to “Handover to Universal Terrestrial Radio Access Network (UTRAN) should be performed”.

Operation 3. The BSC passes a HANDOVER REQUIRED message to the MSC.

Operation 4. The MSC indicates, through Radio Access Bearer (RAB) parameters of the RELOCATION REQUEST message, to the Radio Network Controller (RNC) that a 64k bearer is required.

Operation 5. The target RNC sends a RELOCATION REQUEST ACK message to the MSC informing the MSC that the resources for the MS have been successfully allocated in the target cell.

Operation 6. The MSC sends the HANDOVER COMMAND message to the BSC indicating that the MS should be instructed to move to a Universal Terrestrial Radio Access Network (UTRAN).

Operation 7. The BSC sends the INTER SYSTEM HANDOVER TO UTRAN COMMAND message to the MS commanding the MS to move to the new cell.

Operation 8. Once the MS arrives in UTRAN coverage, the MS synchronizes with a receiver (e.g., B-party) and establishes the RRC connection.

Operation 9. The target RNC informs the MSC, with the RELOCATION COMPLETE message, that the MS has been successfully completed the handover to the UTRAN procedures. Upon successful handover to the UTRAN, the MSC clears the resources allocated in the BSC (both radio resources and A interface).

Operation 10. After the user terminal/mobile station arrives on the UTRAN cell the MSC indicates to the user terminal/mobile station that the establishment of the video call is progressing by sending a CALL PROCEEDING message.

Operation 11. The MSC sends an initial address message (IAM) towards the receiver (e.g., the B-party).

Operation 12. The set-up of the video call successfully proceeds and the users are engaged in the video call.

Operation 13. The MS recognizes that the quality performance level of the video call coverage has dropped close to the acceptable quality threshold level required for the bearer circuit to support the video call. Generally, the bearer is 64k, but could be any other data rate required to support the video call.

Operation 14. The MS places the video call on hold, and initiates the set-up of the voice call.

Operation 15. Alternatively, the video call may be terminated to free the resources and then the voice call may be set-up. According to an embodiment of the present invention, the set-up of the back-up voice call is performed only when the coverage drops too low to support the video call. Hence, wasting of resources can be avoided because there is no voice call on hold for a time duration that the video call is active.

Operation 16. The MS sends a SETUP message to the MSC requesting the voice call.

Operation 17. The CALL PROCEEDING message is then transmitted to the MS from the MSC indicating that the MS has been allocated the receiver (i.e., the B-party) for the voice call.

Operation 18. The MSC sends an initial address message (IAM) requesting the establishment of the voice call towards the B-party.

Operation 19. The MSC receives an address complete message (ACM) from the B-party.

Operation 20. The MSC informs the user terminal/mobile station that the B-party has alerted the user using an ALERTING message.

Operation 21. An answer message (ANM) is received by the MSC when the B-party user has answered.

Operation 22. A CONNECT message is sent to the MS by the MSC to indicate that the call has been connected.

Operation 23. The MS acknowledges the reception of the CONNECT message with a CONNECT ACK message.

According to an alternative embodiment of the present invention, in operations 14-15 above, instead of the video call being put on hold or being terminated, the MS may either dynamically/automatically or through user intervention, initiate the set-up of the voice call while maintaining the video call. That is, the video call may be continued until the voice call set-up is completed. Here too, according to an embodiment of the present invention, the set-up of the voice call may be performed only in case the coverage drops too low to support the video call. Hence, the wasting of resources can be avoided. Furthermore, resource wasting is avoided because there is no voice call on hold when the coverage is above the acceptable quality threshold level to maintain the video call (i.e., the video call is active). In addition, the present invention allows for avoidance of breaks in service when the call is swapped or switched from video to voice or vice versa.

A person of ordinary skill in the art will appreciate that the functions performed in the various operations, such as in operations 14 and 15, may also be performed in a different order than has been described above.

In addition, in either of the embodiments described above, the MS may display a state of the video call. Also, as described in the embodiments previously set forth, the MS may either take the following actions autonomously/dynamically or give the user the ability to take action: place the video call on hold, terminate the video call, set-up the voice call, or swap the video and voice calls. One or more of these actions can be taken or initiated by the user, in any sequence, in the event that the video call is in danger of being close to or below the unacceptable quality threshold level.

In the case where the voice call is swapped with the video call and where the conditions have since improved to the point where the MS determines that the video call can be set-up, one or more of the following set of actions, in any sequence, may be initiated either by the MS autonomously or through user intervention: place the voice call on hold, terminate the voice call, set-up the video call, or swap the voice call with the video call.

In another embodiment, core network based mechanisms may be introduced to swap between the voice and the video call. In these core network based mechanisms, the network elements, such as the BSC, RNC, MSC, etc., may monitor the quality of the video call coverage and the signal strength of the available radio cells and when the video call goes below the acceptable quality threshold level required to maintain the video call, one or more of the network elements may activate or re-activate the voice call.

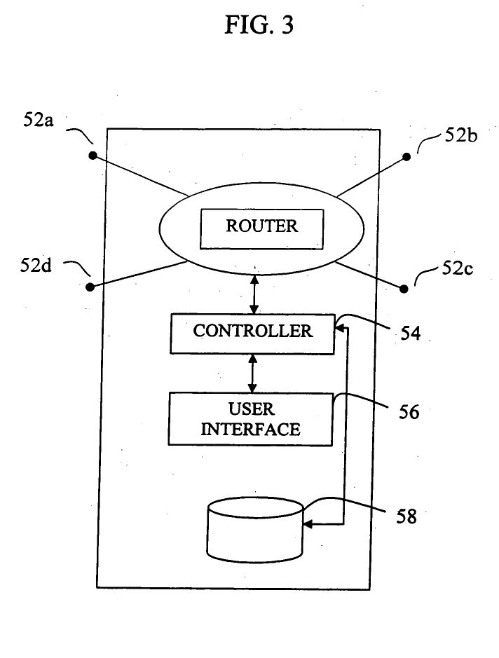

FIG. 3 an exemplary mobile station (MS) 50 to communicate with one or more communication networks or stand-alone devices and to monitor the quality performance level of the video call and the signal strength of the available radio cells, in accordance with an embodiment of the present invention. The functional components of MS 50 may include one or more interfaces 52 for enabling communication with networks and stand-alone devices, a controller 54, one or more user interfaces 56, a memory 58, and a router 60. The MS 50 may also include any other appropriate components, including but not limited to, a power source, an amplifier, one or more digital signal processors (DSPs), and an analog-to-digital/digital-to-analog converter.

In general, the MS 50 supports data communications sessions with one or more receiver devices operatively connected to the MS 50 using one or more wireless or wireline communication links. The MS 50 may include at least one interface 52 coupling MS 50 to one or more stand-alone devices or networks using an appropriate type of communication link. As an example only and not by way of limitation, the MS 50 may include an interface 52a for communicating with a TDMA network, an interface 52b for communicating with a CDMA network, an interface for communicating with the IP Network illustrated in FIG. 1, and an interface 52d for communicating with one or more Bluetooth devices. Any appropriate number and type of interfaces 52 may be included. Furthermore, interfaces 52 may be implemented as any suitable combination of hardware and/or software.

The controller 54 manages the operation of components in the MS 50. For example, controller 54 may be a processor that executes software stored in memory 58, receives input from one or more user interfaces 56 for use in executing the software, and communicates output of the software to the user of the MS 50 using one or more user interfaces 56. The memory 58 may store software applications (including firmware) for swapping the video call with the voice call, in accordance with an embodiment of the present invention, and for providing wireless and/or wireline communications services, as well as other features and functions, to the user of MS 50.

The controller 54, user interfaces 56, and memory 128 may be implemented as any suitable combination of hardware and/or software. As an example only, MS 50 may include a touch screen that serves as both a user input (e.g., a keypad) and output interfaces 56 to display the video image part of the video call. Furthermore, MS 50 may include a microphone and speaker as the user interfaces 56 that allow the user of the MS to place the voice part of the vide call or the voice call to one or more devices communicating with the MS 50.

In addition to the components described above, the MS 50 also includes one or more routers 60. The router 60 may be implemented as any appropriate combination of hardware and/or software and may route communications having any suitable format. Router 60 (or associated hardware and/or software components) may also convert communications into an appropriate format for transmission over a communication link or for processing at MS 50.

Thus, the controller 54 may establish and/or control the video and voice calls using appropriate software stored in the memory 58. Using the software, the controller 54 establishes the video call between the MS 50 another MS, for instance. Based on triggering rules in the software stored in the memory 58, the controller 54 monitors the quality performance level of the video call to support the video call within an acceptable operating level. The controller 54 may monitor the quality performance level at predetermined times or continuously. The controller 54 then determines whether the quality performance level of the video call is less than the quality threshold level. When the quality performance level is below the quality threshold level, the controller 54 establishes the voice call and dynamically swaps the video call with the voice call. Thus, the controller 54 dynamically swaps the video call with the voice call and vice-versa based on determining the quality performance level and signal strength of the available radio cells.

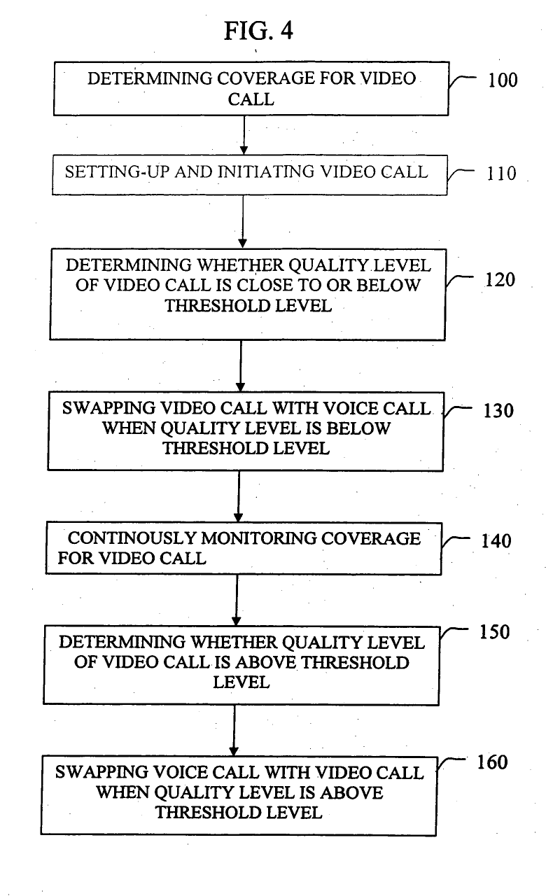

FIG. 4 illustrates a method performed to swap the video call with the voice call, in accordance with an embodiment of the present invention. At operation 100, the method determines the quality performance level for coverage of the video call. At operation 110, if the coverage is above the acceptable quality threshold level, the video call is set-up and initiated as, for instance, described in operations 1-12 of FIG. 2. At operation 120, the method monitors the quality performance level of the voice call and determines whether the quality performance level of the video call coverage has dropped close to or below the acceptable level required to support the video call.

At operation 130, if the method determines that the quality performance level of the voice call has dropped close to or below the acceptable level, the video call is dynamically swapped with the voice call. For instance, the video call may be placed on hold during the set-up of the voice call or, in the alternative; the video call may be terminated. The voice call is then initialized and set-up as, for instance, described in operations 16-23 of FIG. 2.

At operation 140, the method continuously monitors the coverage for the video call and the signal strength of the available radio cells. A person of ordinary skill in the art will appreciate that operations 130 and 140 may be simultaneously performed. That is, the continuous monitoring of the video call may be performed at all times, including when swapping the video call with the voice call after the method has determined that the quality performance level of the video call is below the acceptable quality threshold level and signal strength. At operation 150, during the continuous monitoring, if the method determines that the coverage for the video call is now above the acceptable quality threshold level, the video call is again initialized and set-up.

In one instance, the triggering rule may determine that the voice call is to be established only when the MS 50 and method of the present invention determine that service coverage for the video call has degraded close to or below the unacceptable quality threshold level or if the user wishes not to be on the video call. If the user does not wish to be on the video call, in an exemplary embodiment, the user terminal may include a key or keys to allow the user to select the type of call to be connected to, i.e., the video call or the voice call. Subsequently, another triggering rule could allow the MS 50 and method thereof to re-establish or swap back to the video call upon detection that video coverage is recovered, that is, that the video call is above an acceptable quality threshold level.

In another instance, the MS 50 and method thereof may include a triggering rule to establish a back-up voice call only if the quality of the video call has degraded close to or below the unacceptable quality threshold level. When the video call reaches the unacceptable quality threshold level, a message may be triggered to the user indicating that service coverage for the video call has degraded close to or below the unacceptable quality threshold level. The video call is then deactivated and the voice call is triggered and set-up automatically. In an alternative, the video call may be maintained until the set-up for the voice call is complete and the voice call is active. In addition, if the coverage quality improves close to the level of supporting video, then the video call can be re-established.

The voice and video calls may be charged completely separately, and the user may therefore see two calls on his/her bill, as there may be no association between the voice and video calls in the network. In the alternative, the network may be set-up such that a database therein includes correlation information between the video call and the voice call and the correlation information is included in the call set-up of both, the video call and the voice call. One of the many advantages of the present invention is that the MS 50 and method thereof described herein do not impact existing interfaces and networks.

Thus, in accordance with an embodiment of the present invention, a mobile station and method thereof are provided to allow dynamic swapping from a video call to a voice call when a quality of the video call has degraded below a quality threshold level, without impacting standardized interfaces. In one embodiment, the MS and method of the present invention provide a reduction in use of resources by establishing a back-up voice call only if the quality of the video call has degraded below the quality threshold level.

The many features and advantages of the invention are apparent from the detailed specification and, thus, it is intended by the appended claims to cover all such features and advantages of the invention which fall within the true spirit and scope of the invention. Further, since numerous modifications and changes will readily occur to those skilled in the art, it is not desired to limit the invention to the exact construction and operation illustrated and described, and accordingly all suitable modifications and equivalents may be resorted to, falling within the scope of the invention.

1. A mobile station communicating with one or more communication networks or stand-alone devices and monitoring a quality performance level of a video call, comprising:
a controller establishing the video call between the mobile station and a receiver, monitoring the quality performance level of the video call, determining whether the quality performance level of the video call is less than a threshold level, and, when the quality performance level is below the threshold level, establishing the voice call.

2. The mobile station as recited in claim 1, wherein the controller dynamically swaps the video call with the voice call and vice-versa based on determining the quality performance level and signal strength.

3. The mobile station as recited in claim 1, wherein the controller dynamically swaps the video call to the voice call by maintaining the video call until the voice call is established.

4. The mobile station as recited in claim 1, wherein the controller
continuously monitors the quality performance level and signal strength of available radio cells, and
dynamically swaps the voice call back to the video call when the quality performance level is above the threshold level.

5. The mobile station as recited in claim 1, wherein when the controller determines that the quality performance level of the video call is above the threshold level, the controller terminates the voice call and dynamically swaps back to the video call.

6. The mobile station as recited in claim 1, wherein the mobile station further comprises:
a touch screen serving as a user input and output interfaces to display a video image part of the video call; and
a microphone and speaker allowing a user of the mobile station to place the voice call to one or more devices communicating with mobile station.

7. The mobile station as recited in claim 1, further comprising:
a user interface displaying a message indicating that service coverage for the video call is less than the threshold level.

8. The mobile station as recited in claim 1, wherein the controller establishes the voice call as a back-up voice call only if the quality performance level of the video call is less than the threshold level.

9. A method for swapping a video call with a voice call between calling and receiving mobile stations, comprising:
establishing the video call between the calling and receiving mobile stations;
monitoring a quality performance level of the video call;
determining whether the quality performance level of the video call is less than a threshold level;
establishing the voice call when the quality performance level of the video call is below the threshold level; and
dynamically swapping the video call with the voice call when the quality performance level of the video call is below the threshold level.

10. The method as recited in claim 9, wherein the dynamically swapping of the video call with the voice call comprises:
terminating the video call when the quality performance level of the video call is below the threshold level.

11. The method as recited in claim 9, wherein the dynamically swapping of the video call with the voice call comprises:
maintaining the video call until the voice call is established.

12. The method as recited in claim 9, further comprising:
continuously monitoring the quality performance level of the video call and signal strength of available radio cells; and
dynamically swapping the voice call back to the video call when the quality performance level of the video call is above the threshold level.

13. The method as recited in claim 12, comprising:
maintaining the voice call until the video call is established.

14. The method as recited in claim 9, comprising:
terminating the voice call and dynamically swapping back to the video call when the quality performance level of the video call is above the threshold level.

15. The method as recited in claim 9, further comprising:
separately billing a user for the video call and the voice call.

16. The method as recited in claim 9, wherein the dynamic swapping comprises:
switching the video call with the voice call in real time or in an automated manner without human intervention.

17. A method for swapping a video call with a voice call between calling and receiving mobile stations, comprising:
establishing the video call between the calling and receiving mobile stations;
monitoring a quality performance level of the video call;
determining whether the quality performance level of the video call is less than a threshold level;
establishing the voice call when the quality performance level of the video call is below the threshold level;
dynamically swapping the video call with the voice call when the quality performance level of the video call is below the threshold level;
continuously monitoring the quality performance level of the video call and signal strength of available radio cells; and
reestablishing the video call and dynamically swapping the voice call back to the video call when the quality performance level of the video call is above the threshold level.

18. The method as recited in claim 17, wherein the dynamic swapping comprises:
switching the video call with the voice call in real time or in an automated manner without human intervention.

19. The method as recited in claim 17, wherein the dynamically swapping of the video call with the voice call comprises:
terminating the video call when the quality performance level of the video call is below the threshold level.

20. The method as recited in claim 17, wherein the dynamically swapping of the video call with the voice call comprises:
maintaining the video call until the voice call is established.

21. A mobile station communicating with one or more communication networks or stand-alone devices, comprising:
controller means for establishing a video call between the mobile station and a receiver, for monitoring a quality performance level of the video call, for determining whether the quality performance level of the video call is less than a threshold level, and, when the quality performance level is below the threshold level, for establishing the voice call.
